(19) United States
(12) Patent Application Publication
(10) Pub. No.: US 2021/0364542 A1
(43) Pub. Date: Nov. 25, 2021

(54) BATTERY COUNTER-WEIGHT FOR WIRELESS SAILBOAT WIND INSTRUMENT

(71) Applicant: Craig Summers, Halifax (CA)

(72) Inventor: Craig Summers, Halifax (CA)

(21) Appl. No.: 17/045,367

(22) PCT Filed: Mar. 28, 2019
(86) PCT No.: PCT/CA2019/000040

§ 371 Date: Oct. 5, 2020

Related U.S. Application Data
(60) Provisional application No. 62/653,833, filed on Apr. 6, 2018.

(51) Int. Cl. G01P 1/02; G01P 5/07; H01M 50/169; H01M 50/287

(52) U.S. Cl. CPC G01P 1/026; G01P 5/07; H01M 2220/20; H01M 50/287; H01M 50/169

(57) ABSTRACT

Improvements are disclosed here for a sailboat wind sensor (PCT/CA2014/000416) in which the solar panels form the tail of the wind direction arrow, and a digital compass is built into the wind direction arrow. The battery is moved to the nose cone and held in waterproof container to serve as a counter-weight, eliminating the brass nose cone which is traditionally used on anemometers to substantially reduce the weight. A new method of encapsulating the electronics in the tail is disclosed, using ultrasonic welding of a shell over the circuit board, rather than molding a resin over the electronics.

### FIELD OF THE INVENTION

A novel sailboat anemometer design that reduces weight by moving the battery from the tail to use as a counter-weight in the nose cone. Ultrasonic welding is used to seal a lightweight shell on the tail, instead of molded encapsulation of the tail electronics.

### BACKGROUND OF THE INVENTION

A wireless sailboat wind sensor has been previously defined in PCT/CA2014/000416 and US Patent Publication No. 20160370399, which are incorporated herein by reference, in which the solar panels form the tail of the wind direction arrow, and a digital compass is built into the wind direction arrow. That creates a number of advantages, but after about 5 years of customer use and feedback some limitations to the design have been identified.

In order to move in light winds, a wind direction arrow needs to have minimal weight. But this design includes a circuit board, solar panels and battery in the tail of the wind direction arrow. Although that makes the unit self-contained and wireless, a counter-weight is needed in the nose to allow the arrow to balance, which is made of heavy brass (which further adds to the weight).

A second problem with the existing design is that the battery is sealed in the tail to make the electronics waterproof. If the user flattens and damages the battery, there is no way to remove the battery, and the entire product must be replaced.

The battery also has a steel shell, and steel is a ferrous metal meaning it can be magnetized. If the battery shell is magnetized when close to a magnet, laptop, tablet or other object with an electro-magnetic field, the compass no longer responds to the earth's magnetic field, and is stuck in one direction (pointing to the battery). It is not good to have a battery with a steel shell near a highly sensitive digital compass.

Finally, in order to seal the electronics in the tail, the electronics are “potted” or placed in a mold with liquid resin, which hardens into clear plastic around the electronics and solar panel. This process is difficult, time-consuming and expensive for manufacturing in large quantities. The resin is also heavy, but if the molding makes it very thin, there are spots where it does not cover and leaks may occur.

It is also challenging to find suitable resins from suppliers, since most urethane, epoxy and polyester resin tends to eventually amber or deteriorate from UV rays. Also molding the resin with a smooth, clear glossy surface is an ongoing challenge.

### SUMMARY OF THE INVENTION

The original anemometer design disclosed in in PCT/CA2014/000416 was a dramatic departure from traditional anemometers. After five years of use in the field, it is desirable to add some additional novel improvements to the structure. These structural improvements were not obvious originally and are not used in any other anemometers (because there have been very few wireless anemometers).

The original design was novel, in part, because all of the electronics were put in the tail so that it was compact and sealed, with no wires to gradually chafe and no electronics or sensors or gaskets that could get wet or leak. These new structures further improve on the novel design. The disclosed changes are specific to this particular design. Other anemometer designs would generally not need these new features.

In particular, the battery in the electronics in the tail is about the same size as the brass nose cone in the original design. The battery only weighs about one-third as much as the brass nose cone, but once it is removed from the tail, a smaller counterweight can be used. The invention disclosed here with the battery inside the nose cone could only have been discovered after using the original design and gradually seeing its shortcomings. It took years of testing, refinement and new designing to find a better structure.

The reason a counterweight is used on anemometers is to balance the wind direction arrow, so that it can rotate without friction. This is particularly important on sailboat anemometers, since sailboats often move along heeled over at an angle from wind power. If the tail is heavier than the nose (or vice versa), gravity then pulls on the tail, causing it to point up instead of into the wind. But when the nose and tail are balanced, gravity has no effect and the arrow responds only to the wind direction.

Along with being balanced, when a wind direction arrow is not very heavy, it can turn more easily in light winds. So the design could be improved by taking the battery out of the tail, and using the battery as the nose-cone. This allows removing the weight of the brass nose cone. It is a huge improvement to use the battery itself as the counterweight (with appropriate wiring from the battery to the electronics), rather than intentionally adding extra weight to a wind direction arrow that is meant to float in the wind.

This design also has a major advantage by adding a removable battery. That way if customers flatten their battery, they can just buy a replacement. The usual problem with replaceable batteries is that the compartment may leak and damage the electronics. But in this case, the electronics are all still encapsulated in the tail.

Placing the battery in the nose cone to act as the counterweight also creates a distance between the highly sensitive compass and the battery. So if the steel shell on the battery happens to become magnetized, its magnetic field will not affect the compass. That is a valuable side-effect of this design.

Ordinarily a compartment for a removable battery places the electronics at risk. But with this design, the electronics are still completely sealed and waterproof in the tail, with the battery in the nose cone on the end of the pointer arm.

A lightweight shell is placed over the tail electronics, to form the surface of the tail. The solar panels can be underneath the shell if it is clear. But in the preferred embodiment, the solar panels are attached with double-sided tape to the outside of the shell, so that there is no surface obstructing the clarity of the solar panels and reducing sunlight hitting them.

Ultrasonic welding is used to join the two halves of the shell, with several pieces extending out of the shell from the circuit board. Two of these pieces are C-shaped retaining clips for the axle and wind cups. There is also a reinforcement bar to carry some of the circuit board weight to the axle. And the pointer arm connects the circuit board to the nose cone through the axle. It is hollow for the battery wires. Ultrasonic welding creates a hermetic seal around the edges of the case, so that the electronics are sealed inside. Compared to molding resin to encapsulate the tail, ultrasonic welding of a thin shell is faster and easier for volume manufacturing, has less expensive materials, and is much more lightweight.

### BRIEF DESCRIPTION OF THE DRAWINGS

FIG. 1: Main components of anemometer with battery in nose cone.

FIG. 2: Battery container in nose cone.

FIG. 3: Clevis that is glued to carbon fiber tube and bolted to one side of circuit board.

### DETAILED DESCRIPTION OF THE INVENTION

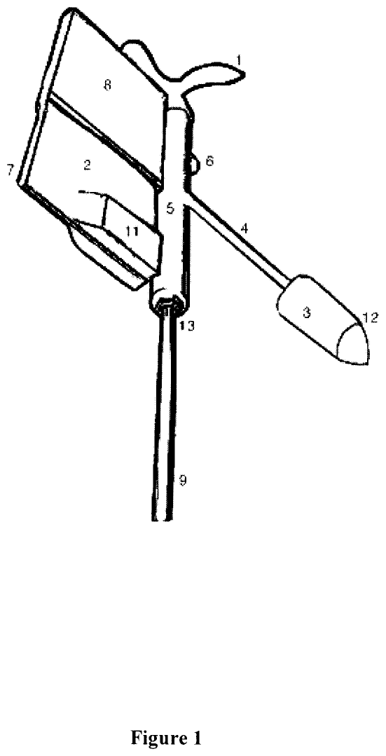

FIG. 1 shows the overall structure of the anemometer, with wind cups 1 to detect wind speed and a tail 2 and nose cone 3 that rotate to detect wind direction. The pointer arm 4 is a hollow tube that connects the tail to the nose cone. A pair of wires runs inside from the battery to the electronics. The arrow rotates on an axle 5 with a pin on the lower end that sits on a V-shaped jewel bearing, to turn to point into the wind with no friction. A reinforcement bar is above the pointer arm, to provide additional structural support, connecting the tail to the axle. A dome nut 6 attaches to the end of the reinforcement bar to hold it tight. The base of the anemometer has a threaded hole for turning onto the mounting rod 9 which is held tight with a lock nut 13.

The circuit board in the tail is sealed inside a plastic shell 7 with ultrasonic welding to make the seal waterproof Solar panels 8 are a thicker area of the tail, attached with double-sided tape on the outside of the plastic shell so that there is nothing obstructing the sun's rays for maximum solar charging. Although the shell over most of the tail is close to the electronics, there is an open air gap 11 over the Bluetooth antenna, to allow the radio waves to propagate for maximum transmission distance.

The cap of the nose cone is somewhat pointed or pointy, like an arrow or bullet going into the wind. This cap threads on to the main battery container, with an O-ring 12 on the threads to provide a watertight seal when tightened. There is a hollow area inside the cap that provides space for a tiny battery connector plug. The battery is shrink-wrapped with wires from the positive and negative ends extending out a few centimeters with a plug on the end. The wire in the pointer arm comes out in the nose cone and has the other side of the battery plug. There is a space in the nose cone beside the battery for the wire so that the battery does not rub and chafe on the wire. The plug and excess wire are stored in the cap when the cap is turned on.

The battery wire runs inside the pointer arm. To further decrease the weight of the wind direction arrow, a hollow tube can be used to run the wire. Carbon fiber is preferred because it is lightweight but very strong, although other materials such as aluminum could be used. When carbon fiber is used for the tube, it must be glued to a clevis to attach to the circuit board, and glued to the nose cone. Carbon fiber is not suitable to use with traditional metal threads or nuts and bolts.

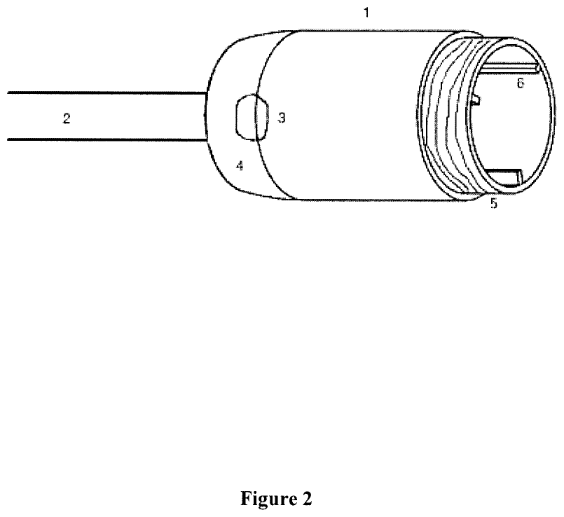

FIG. 2 shows a close-up of the battery container with the cap removed. On the left side, the hollow carbon fiber pointer arm 2 is shown that is press-fit into the base of the battery container and permanently affixed with adhesive. The hole in the nose cone for the carbon fiber tube may be approximately 5 mm in diameter, although there is a narrower hole 3 of approximately 3 mm in the base of the nose cone to let the battery plug and wire through. That narrowing blocks the carbon fiber tube from being pushed through into the battery. There is a solid area 4 in the base of the nose cone to provide reinforcement around the carbon fiber tube. Before the cap is turned onto the threads 5 an O-ring is put on the threads, to ensure a waterproof seal.

Inside the battery container, three ridges are shown that support the battery. One ridge 6 is not as tall as the other two, making the battery off-center, to leave space for the wire to come up the side of the battery without chafing.

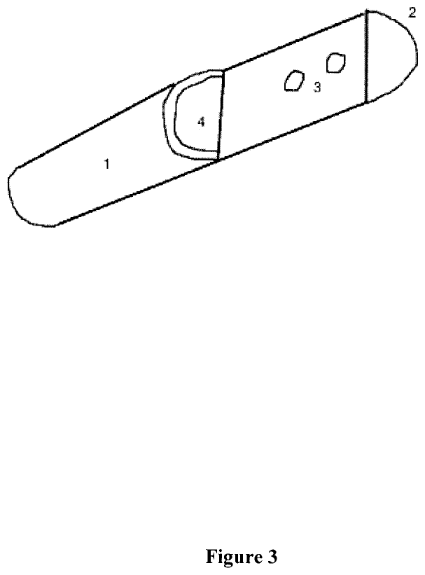

At the end of the pointer arm with the circuit board, a special fastener is needed since the carbon fiber tube cannot be bolted directly to the circuit board. As shown in FIG. 3, this fastener is a type of clevis, with a tube 1 on one end into which the pointer arm is snugly inserted and affixed with adhesive. At the other end 2 the clevis is solid and semi-circular in cross-section, for bolting to one side of the circuit board. There are two holes 3 through the flat part for small machine screws and nuts to fasten to through holes in the circuit board. Most importantly, aside from fastening the pointer arm to the circuit board, the clevis also needs to feed the battery wire to the circuit board. So there is a hole 4 where the wire can exit for soldering to the circuit board. The clevis lets the wire out on one side of the circuit board, and attaches to the other side. The purpose is to fasten the carbon fiber rod to the circuit board, without using screws on the carbon fiber itself.

The scale of the clevis and the carbon fiber tube and nose cone can vary without affecting the spirit and scope of the invention, although in a preferred embodiment, the size of the hollow pointer arm may be 5 mm outer diameter and 3 mm inner diameter. In this embodiment the clevis should have an inner diameter around 5.1 mm, to snugly fit over the tube, and an outer diameter of around 6.5 mm.

Although adhesive could be used to join and seal the two sides of the shell over the circuit board, in the preferred embodiment ultrasonic welding is used to join and seal the two sides of the shell. The two halves are molded to a shape that fits around the circuit board. One side is set on a supportive base, the electronics are sandwiched in the middle, and the other side of the case is set on top. Then a metal fixture is brought down into contact with the edges of the upper part, pressing down on the edges. The upper part vibrates at frequencies in the range of 20,000-40,000 times per second, creating frictional heat between the two plastic sides, melting the plastic. The vibration stops and the plastic cools. The clamping down is maintained until the plastic cools and solidifies. The two plastic sides are now joined as one, providing a hermetic seal of the electronics inside. This is a fast, strong, clean and repeatable manufacturing process with no solvents, molded resin or adhesives involved.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

The scope of the claims that follow is not limited by the embodiments set forth in the description. The claims should be given the broadest purposive construction consistent with the description and figures as a whole.

What is claimed is:

1. An anemometer for wind speed and direction comprising a tail, axle, cups, mounting rod, pointer arm and nose cone, wherein the electronics in the tail are hermetically sealed inside a lightweight plastic shell and the battery is a counterweight in the nose cone.

2. The anemometer of claim 1, wherein the pointer arm for the wind direction arrow comprises a hollow tube extending from the circuit board in the tail to the nose cone with a wire inside.

3. The anemometer of claim 2, wherein the wire has a small plug on the end that can plug into a shrink-wrapped battery with a wire and plug on it.

4. The anemometer of claim 1, wherein a hole in the base of the nose cone is attached to the hollow pointer arm with adhesive, through which the battery wire comes into the nose cone.

5. The anemometer of claim 1, wherein the nose cone has a space up the side of the battery for the wire to avoid chafing of the wire, and a space inside the cap for the plug on the end of the wire to plug into the battery wire.

6. The anemometer of claim 1, wherein the cap for the nose cone turns on threads onto the nose cone, with an O-ring around the base of the threads to ensure a waterproof seal.

7. The anemometer of claim 1, wherein the hollow pointer arm attaches to the circuit board in the tail using a hollow clevis fastener, with adhesive joining the clevis to the pointer arm, and the clevis attached onto one side of the circuit board with a small pair of nuts and bolts, and the battery wire exiting from the tube on the other side of the circuit board.

8. The anemometer of claim 1, wherein the electronics in the tail are hermetically sealed inside a lightweight shell using adhesive or ultrasonic welding to join the two sides of the case.

9. The anemometer of claim 1, wherein the tail is comprised of the solar panels and circuit board, and the solar panels are attached with double-sided tape to the outside of the plastic shell encapsulating the electronics, to provide clearer sunlight to the solar cells.

10. The anemometer of claim 1, wherein the hermetically sealed shell around the tail electronics provides an air gap over the radio antenna, allowing the air molecules to vibrate and transmit out in radio waves, with no need for an additional box around the antenna to keep resin away and form an air gap.
